(19) United States
(12) Patent Application Publication
(10) Pub. No.: US 2007/0185828 A1
(43) Pub. Date: Aug. 9, 2007

(54) Graphical portal in an information management system and process

(76) Inventor: Michael S. Brown, Wilmington, NC (US)

Correspondence Address: DICKSTEIN SHAPIRO LLP, 1825 EYE STREET NW, Washington, DC, 20006-5403, US

(21) Appl. No.: 11/520,027

(22) Filed: Sep. 13, 2006

Related U.S. Application Data
(60) Provisional application No. 60/716,498, filed on Sep. 14, 2005.

(51) Int. Cl. G06F 17/30; G06F 7/00

(52) U.S. Cl. 707/1

(57) ABSTRACT

A graphical portal in an information management system, said system comprising a host computer and software capable of allowing a user to publish a drawings representing items in an environment, such as a laboratory, on an intranet, and allowing a user to remotely access the drawing.

### FIELD OF THE INVENTION

The invention relates to a method and system for providing increased graphical functionality in an Information Management System, such as a Laboratory Information Management System (LIMS).

### BACKGROUND OF THE INVENTION

A LIMS is typically a highly complex configurable software application used for handling data generated by analytical chemistry instrumentation, methods or procedures and associated workflows. In a LIMS, laboratory data handling and mining capabilities are typically automated. Data storage is handled by a back-end relational database. An example of a relational database is the Oracle databases which are considered the standard for supporting data storage and retrieval laboratory management within chemical and pharmaceutical operations. However, other commercially available databases may be utilized.

An example of a commercially available LIMS system includes Thermo Electron Corporation's SampleManager™, which is a LIMS system in which advanced data mapping and parsing can process data from a variety of instrument types and multiple vendors to replace traditional “point” solutions. SampleManager™ automatically manages instrument data for secure transfer and storage in the SampleManager™ LIMS database, eliminating manual transcription errors and improving the flow and management of laboratory data. Web pages relating to the features and uses of the LIMS system may be displayed through a web browser feature of the system.

Microsoft Visio®, a commercially available program from Microsoft Corporation, Redmond, Wash., is one example of a diagramming program that provides the capability to create business and technical diagrams that document and organize complex ideas, processes, and systems. Diagrams created in Visio® enable the visualization and communication of information in a clear, concise, and effective graphical manner. Visio® provides the automation of data visualization by synchronizing directly with data sources to provide up-to-date diagrams. Visio® also provides the ability to extract data from Visio® diagrams and import it into other applications and formats, including web pages. Visio® allows advanced workflow modeling and scenario planning in LIMS applications.

Shapes created in Visio® can be associated with run-time behavior as described below. Visio® provides a published object model that facilitates connecting active components to a Visio® shape. Once connected, Visio® documents, pages, and shapes can easily be manipulated, by custom-designed components, using the properties, methods, and events made available by Visio®. Thus, Visio® objects can control operations outside of Visio® and operations outside of Visio® can control Visio® objects. While the description has been discussed herein with reference to Visio®, it should be understood that any suitable diagramming program may be used in the present invention.

SampleManager™'s standard user interface simplifies training and deployment. Any file relating to a laboratory instrument can be mapped to a SampleManager™ data field. A standard user interface is utilized for all types and brands of instruments, offering consistency throughout the laboratory and throughout the organization, reducing training requirements, accelerating implementation, and ensuring the integrity of data. Even in very high throughput environments, information from the latest models of instrumentation can accurately and quickly be delivered to users, laboratory management and other authorized decision-makers—increasing productivity in the laboratory and lowering the total cost of LIMS deployment. One reason for the increase in accuracy and speed is due to the ability of LIMS to host .htm, .html, .asp and aspx pages. These pages establish the ability of the SampleManager™ Active Desktop to interact with fields and records or procedures stored within the database via HTML anchored reference links. These features are supported by default with a standard LIMS installation.

LIMS applications may include a built-in web browser. The built in web browser in the SampleManager™ program, for example, is termed “The Active Desktop”. The Active Desktop is essentially a customized instance of the default Internet Explorer program which is integrated into the Windows operating systems by Microsoft Corporation, Redmond, Wash. The Active Desktop functionality provides a flexible platform to display web content in the form of HTML and Active Server Pages. The power of this flexibility is well documented and displayed in LIMS training examples and manuals. The term “Active Desktop” is used hereinafter to refer to the web browsers within all LIMS systems and the invention should not be limited for use with the web browser within SampleManager™.

Typically, the web pages displayed through the Active Desktop use a single graphic file with hyperlinked hotspots written into the HTML as bounded regions. However, laboratory operations and processes are quite complex and much effort is required to update the static graphics and hotspots. Accordingly, there is a need and desire to provide increased graphical functionality within LIMS.

### SUMMARY OF THE INVENTION

The present invention utilizes the capabilities of Visio® to create web pages containing information for viewing through the Active Desktop without the need for the vendor to customize the application. The present invention further creates an instrument management information portal to create and publish web pages directly from Visio® to link configuration planning and management, calibration history, instrument manuals, certificates, instrument errors, and the like, for example, through a single instrument icon.

The present invention further allows quick manipulation of graphics files and exportation of information into a webpage. Also, since the number of Visio® templates, stencils and drawings used to provide workflow analysis is rapidly increasing, the present invention allows efficient integration and support of graphical workflow management diagrams. Finally, the quick resizing and rendering capabilities allows the resizing of objects to make extended viewing comfortable.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 is an exemplary screen shot illustrating a scaled webpage according to an embodiment of the invention;

FIG. 2 is an exemplary screen shot illustrating a step in the creation of a MasterShape from a pre-existing Shape according to an embodiment of the invention;

FIG. 3 is an exemplary screen shot illustrating a step in the editing of a saved stencil according to an embodiment of the invention;

FIG. 4 illustrates an exemplary screen shot for selecting a MasterShape to edit according to an embodiment of the invention;

FIG. 5 is an exemplary screen shot illustrating a step in the customization of a Shape according to an embodiment of the invention;

FIG. 6 illustrates an exemplary screen shot of the fields used to define custom Shape properties according to an embodiment of the invention;

FIG. 7 illustrates an exemplary screen shot of the fields used to define custom Shape properties according to an embodiment of the invention;

FIG. 8 illustrates an exemplary screen shot of custom graphical icons and a Visio® toolbar according to an embodiment of the invention;

FIG. 9 illustrates an exemplary screen shot for entering hyperlink information and properties according to an embodiment of the invention;

FIG. 10 illustrates an exemplary screen shot of a customized Visio® webpage linking together instrument information with graphical icons according to an embodiment of the invention;

FIG. 11 illustrates an exemplary screen shot of a ShapeSheet of a Shape according to an embodiment of the invention;

FIG. 12 illustrates an exemplary screen shot for entering hyperlink information and properties according to an embodiment of the invention;

FIG. 13 illustrates an exemplary screen shot of saving a Visio® document as a webpage according to an embodiment of the invention;

FIG. 14 illustrates an exemplary screen shot of the fields used to define the properties of a Visio® webpage according to an embodiment of the invention;

FIG. 15 illustrates an exemplary screen shot for selecting the publication location of a webpage according to an embodiment of the invention;

FIG. 16 illustrates an exemplary screen shot of a generic stencil viewed through the Active Desktop;

FIG. 17 illustrates an exemplary screen shot of a generic stencil viewed through the Active Desktop;

FIG. 18 illustrates an exemplary screen shot of a generic stencil viewed through the Active Desktop;

FIG. 19 illustrates an exemplary screen shot of a generic stencil viewed through the Active Desktop;

FIG. 20 illustrates an exemplary process flowchart according to the present invention;

FIG. 21 illustrates an exemplary block diagram of the creation of instrument configuration shapes according to an embodiment of the invention;

FIG. 22 illustrates an exemplary screen shot for selecting a diagram category;

FIG. 23 illustrates an exemplary screen shot of the Startup Wizard in Visio®;

FIG. 24 illustrates an exemplary Visio® screen shot in which Boundary Shapes may be added to the drawing;

FIG. 25 illustrates an exemplary screen shot of a configured floor plan;

FIG. 26 illustrates an exemplary screen shot of a configured floor plan; and

FIG. 27 illustrates a Visio® designed webpage displayed using the SampleManager™ Active Desktop according to an exemplary embodiment of the invention.

### DETAILED DESCRIPTION OF THE INVENTION

In the following detailed description, reference is made to the accompanying drawings which form a part hereof, and in which are shown by way of illustration specific embodiments in which the invention may be practiced. These embodiments are described in sufficient detail to enable those skilled in the art to practice the invention, and it is to be understood that other embodiments may be utilized, and that structural and logical changes may be made without departing from the spirit and scope of the present invention.

The present invention includes the use of a host computer which in turn includes memory such as random access memory (RAM) and a central processing unit (CPU or processor). The system's CPU manipulates data stored in the system's memory. These manipulations occur according to various algorithms also stored in memory. Data manipulated according to the system's algorithms may be derived from an external source apart from the system and relayed to the system via a communication network such as the World Wide Web in one embodiment. The system may be interfaced by a user through an interactive webpage displayed through an information management system, such as, without limitation, a laboratory information management system (LIMS).

In general, the embodiments of this invention utilize the capabilities of diagramming software, such as, for example, Visio®, to create web pages containing laboratory information for viewing through LIMS applications. The web pages have a built-in web browser, such as, for example, the Active Desktop. As a result, there is no need for the LIMS vendor to customize the LIMS application.

Using the LIMS application having a built-in web browser, such as, for example, the Active Desktop to graphically model or storyboard laboratory workflows, according to an exemplary embodiment of the invention, provides immediate system use without the need for extensive training to navigate the application.

In order to further increase the capabilities of a LIMS application having a built-in web browser, e.g., the Active Desktop, the features and functionality of the diagramming programming, e.g., Microsoft Visio® can be combined with LIMS. Typically, capturing and reporting instrument errors, configuration and maintenance information is excessively time consuming. However, according to an exemplary embodiment of the invention, existing lab layouts, which were created within Visio®, can be immediately and quickly converted to web pages to reduce the configuration and maintenance burden and provide increased graphical functionality. The graphics displayed on the web pages link all of the documentation, reports, errors and other information relating to an instrument together in an easily accessible manner, often through a single instrument icon.

The functionality and utility of LIMS can be extended by utilizing a combination of the properties of web pages, drawings, stencils, templates and shapes created by, for example, the Microsoft Visio® 2003 Professional program and displaying the web pages through the LIMS Active Desktop. Installation of the Visio® Viewer 2003 allows native Visio® files to be displayed directly, for example, through the LIMS Active Desktop.

Representation of information in a graphical format enhances productivity by allowing both logistical and risk assessments to be expedited at critical decision points which impact Good Manufacturing Practices (GxP) regulated laboratory operations and processes. Native Visio® binary files can be viewed directly through the Active Desktop when a Visio Viewer plug-in is installed. This adds enhanced capabilities to the SampleManager™ Active Desktop, for example, by allowing Visio® generated documents resident within other applications (e.g., Documentum a commercially available product from EMC², Trackwise® a commercially available product from Sparta System, Inc.) to be viewed.

In the alternative, drawings maybe viewed from a controlled storage application, such as, for example, Documentum™ and/or assigned an embedded trigger to initiate the Trackwise™ application to monitor the lifecycle of proposed changes, reviews and change control approvals. It is also possible to link to Documentum™ and Trackwise™. If links and triggers between the three applications are formed, then a UML based workflow design model could be generated.

The LIMS Active Desktop may also be customized. According to the present invention, each user of the LIMS system may have an individual Active Desktop homepage which is loaded when the user logs into LIMS. The custom-made web pages, including any images, may be stored with the LIMS HTML files.

In pharmaceutical operations, such as for example, laboratories, it is often necessary to document laboratory configurations regarding the instruments and their locations, including communication connectivity descriptions for either standalone or networked application installations as part of validation requirements. Accordingly, the present invention and associated workflow models support adherence to GxP guidelines and Validation Best Practices. The invention allows for efficient change control documentation for the Configuration Management Process.

The present invention provides a graphical interface, such as, for example, Visio® web pages, that links together multiple sources of information for laboratory instruments. Exemplary laboratory instruments include, for example, a bath temperature probe, a column heater, a mass spectrometer, a calorimeter, a nuclear magnetic resonance device, a gas analyzer, or the like, through at least one icon. For example, the information that may linked through an instrument icon according to the present invention may include configuration planning and management information, calibration history, instrument manuals, certificates, and instrument errors. The graphic icons, by utilizing the underlying programming, organize static data, graphics and fine tune and optimize a laboratory instrument layout, for example, for display through the Active Desktop.

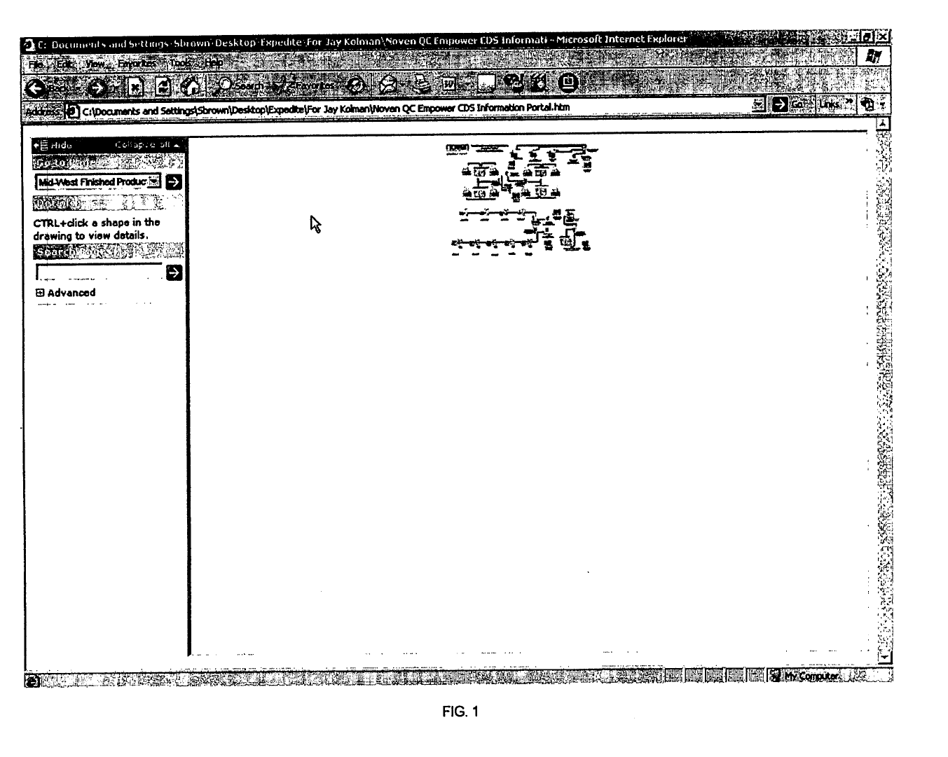

Greater control of individual graphics (termed Shapes and MasterShapes in Visio®) which represent static objects or process activities may be achieved by the utilization of web pages, drawings, stencils, templates and shapes created with Visio® and displayed through the Active Desktop as it makes the user interface simpler, allows for easier training for users and allows the support of advanced languages such as, for example, UML. This is an improvement over using a single graphic image with mapped hotspots embedded within a standard HTML or active server page. The diagramming program contains optimized resolution settings to format web pages specifically for handhelds or a Tablet PC. The custom sized web pages can support GPS enabled analytical instruments to send text or visual messages from the instrument to a device resource management server (DRM) or intermediate contact for instrument error alerts. For example, if a particular Visio® webpage will regularly be viewed from a handheld device (e.g., cell phone, personal assistance device, or the like) the webpage may be sized such that it is easily viewable on the handheld device, as illustrated in FIG. 1. The Visio® web pages may also be customized to provide searchable attributes.

Each shape (i.e., Shape or MasterShape) created in Visio® is described in its own ShapeSheet spreadsheet, which contains information about the shape's geometry and its other properties. For example, the ShapeSheet spreadsheet contains a shape's dimensions and the x- and y-coordinates of each of its vertices. Much of the information in the ShapeSheet can be defined by using formulas rather than hard-coded numbers. By using formulas, a shape can behave differently depending upon its context. A formula can include standard mathematical and logical operators and functions. A few user-defined cells are added to the ShapeSheet for some shapes to identify the shape when it is dropped onto a page. In an exemplary embodiment, ShapeSheets may be created for each instrument vendor.

Further, according to the present invention embedded details and descriptions associated with Shapes and MasterShapes can optionally be displayed or hidden from view by the content author. Custom properties can be created for each shape which can store default information about the instrument and/or dynamic processes. Custom properties added to shapes may be used in combination with the ShapeSheet to control and/or perform extended functions. For example, if the custom properties of an instrument MasterShape are set to request information from the content editor, then these values can be saved as part of the shape on the page which may then be used to generate unique identities between the representative Shape and a record within the database.

In general, a shape displayed on the Visio® webpage could respond in the same manner as the traditional mouseover, mouseoff features used in JavaScripts. However, layer controls may exist for each shape based on the formulas stored in the ShapeSheet. For example, if the calibration date of an instrument is called from SampleManager™ this value could be passed to a different cell for inclusion in a ShapeSheet formula for different alerts. Examples of such alerts include flashing an orange light on the instrument three days from a calibration date to represent a calibration deadline is soon approaching, or flashing a red light one day from a calibration date to indicate instrument calibration is near out of range and will produce an reportable incident.

A central part of Visio® is the stencil, which typically contain shapes having related functions, such as dimensioning or flow charting. The user can build complex diagrams by dragging shapes from the stencil and dropping them onto the page of a Visio® document. The shapes on the stencil are called MasterShapes. The Technical and Professional versions of Visio® provide a number of useful shapes, such as the dimension shapes on the standard Engineering stencils.

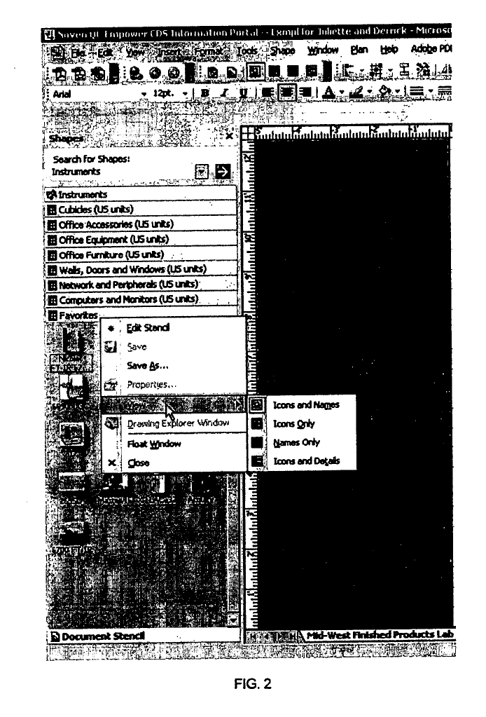

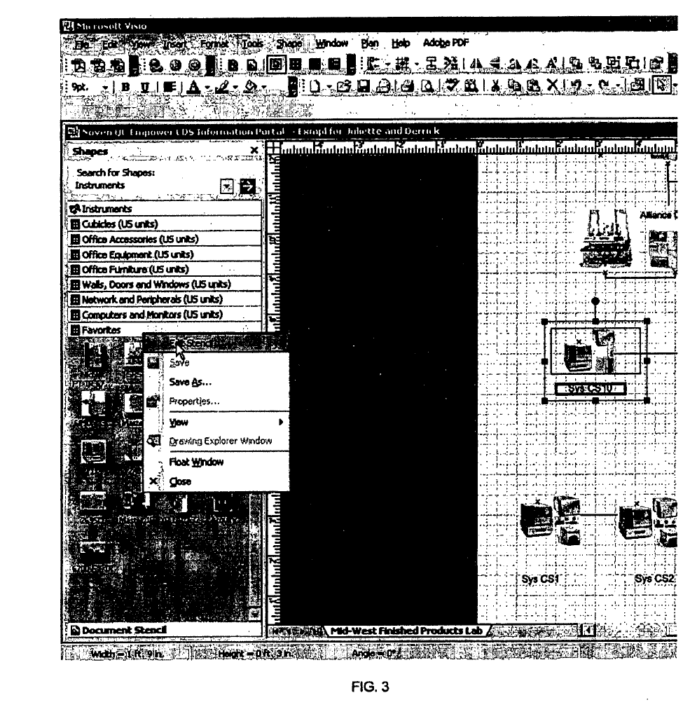

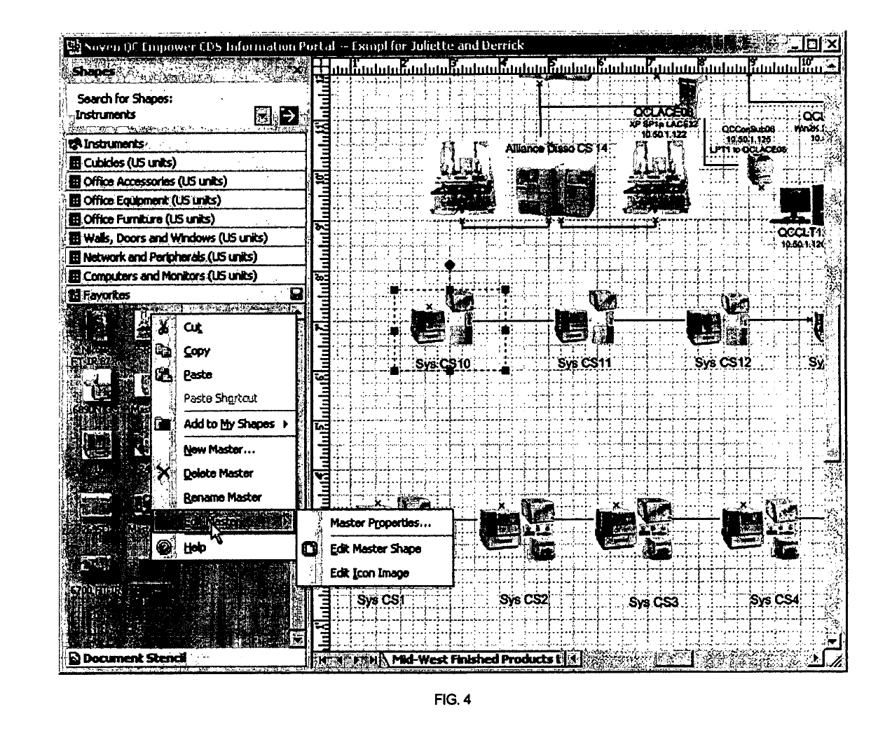

Shapes and MasterShapes may be created and modified for use in stencils. A MasterShape can be created from a pre-existing shape within a drawing by right clicking on the shape in the drawing windows and selecting copy. Alternatively, the user may click on and hold the shape of interest and drag it onto the Stencil Pane. Next, by right-clicking on the newly created MasterShape, the MasterShape may be edited, renamed, added to a new or pre-existing stencil. The MasterShapes may be viewed by selecting Icons and Names, Icons only, Names only, or Icon and Details, as illustrated in FIG. 2. After the MasterShape is placed on the drawing window, the MasterShape may be renamed. Shapes which are created from a MasterShape will inherit all the properties, including custom properties, associated with the MasterShape. This feature is especially useful if the drawing is run against the Database Wizard Add-on where shapes may be directly linked to records or fields within a compliant database. Further, a Shape maybe assigned to a row within an Excel spreadsheet. As illustrated in FIG. 3, the Stencil maybe edited or customized based on the intended use (e.g., a laboratory implementation). Further, as illustrated in FIG. 4, a MasterShape may be edited to assign default properties that are applied when a Shape is created using the MasterShape.

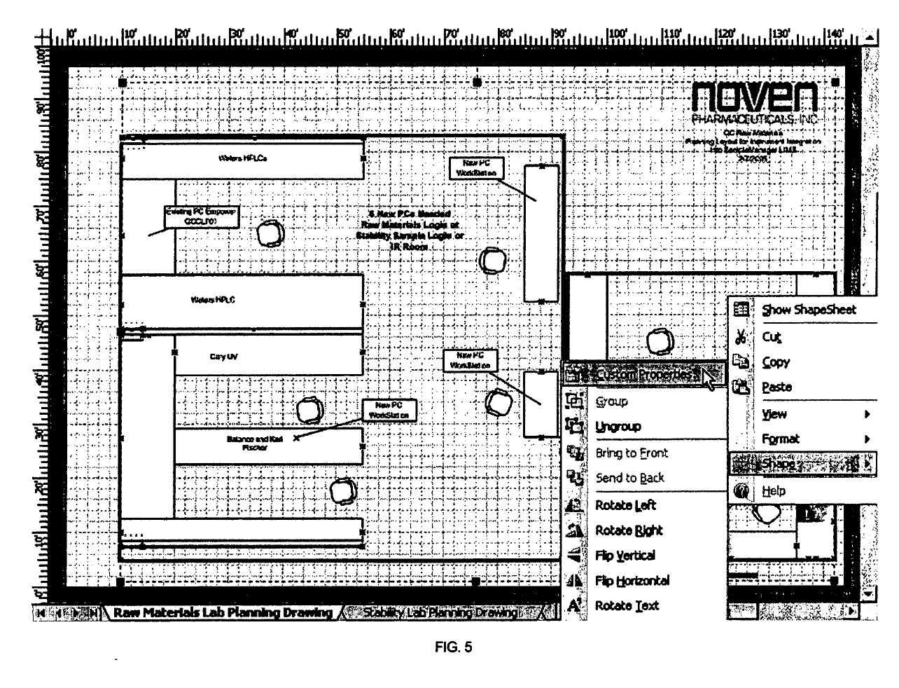

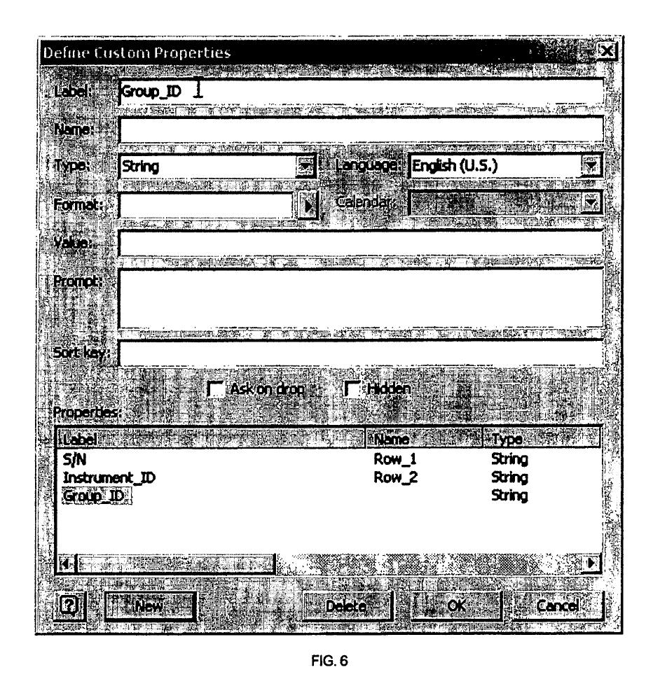

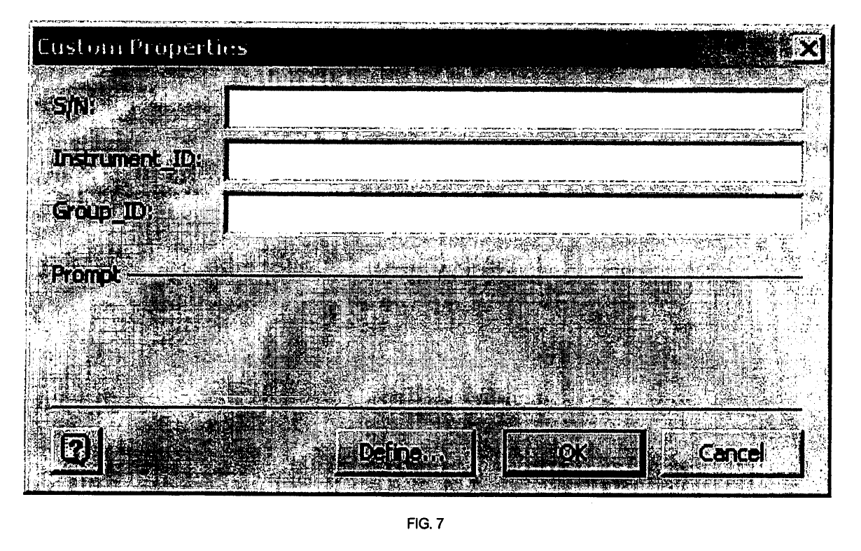

Custom properties may also be added to each individual Shape, as illustrated in FIGS. 5-7. FIG. 5 illustrates a custom lab layout in which the user is selecting to add custom properties to a shape. FIGS. 6-7 illustrate exemplary screen shots in which the custom properties are entered. The custom properties include the property name, type, format, value, etc. Descriptive information may also be added to each textbox and stored with the Shape. Once all settings are entered in the screens illustrated in FIGS. 6-7, the settings are saved. The Shape may then be used to generate additional templates or shapes. In a LIMS system, custom properties of an instrument MasterShape, for example, may be set to request information entry from the content editor. This information will be saved as a part of the shape on the page which can then be used generate unique identities between the representative Shape and a record within the database.

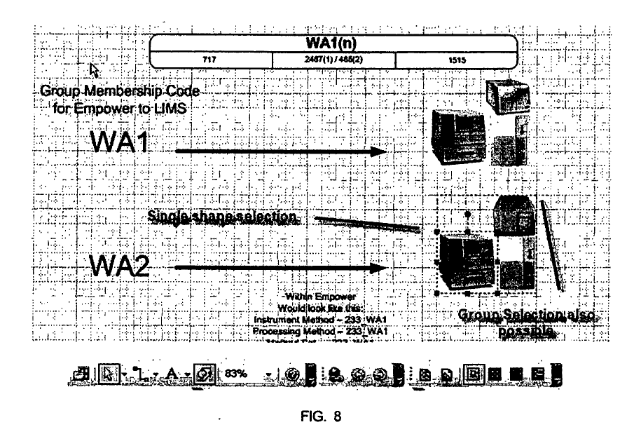

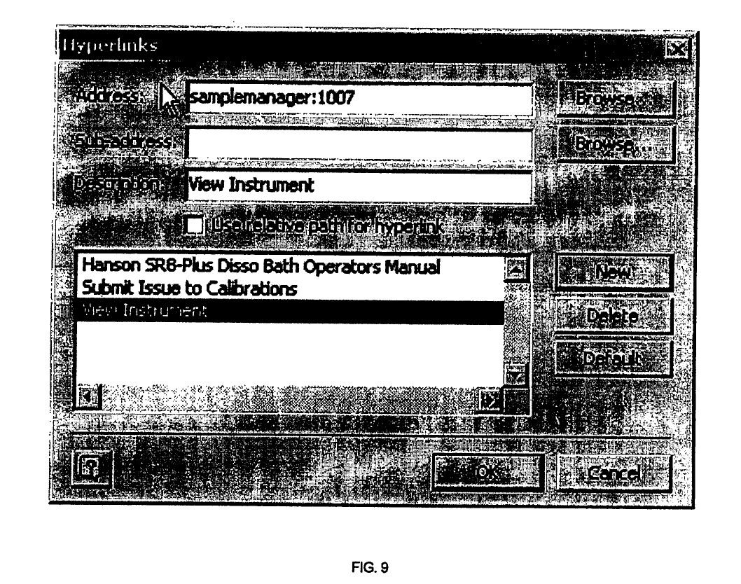

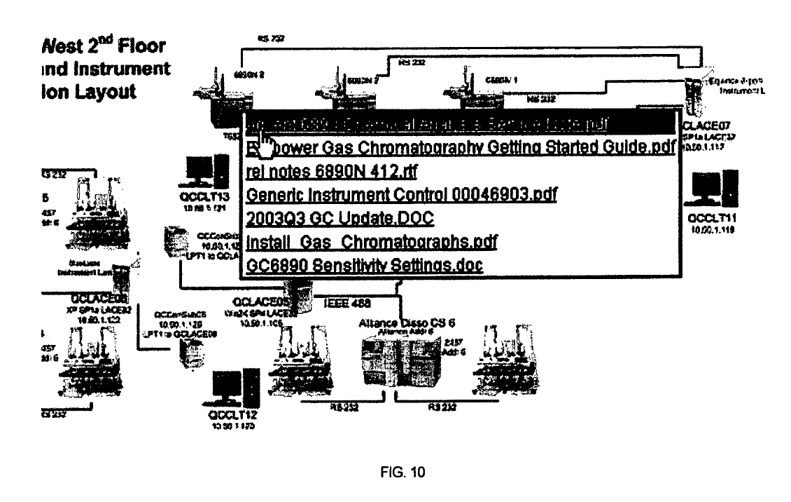

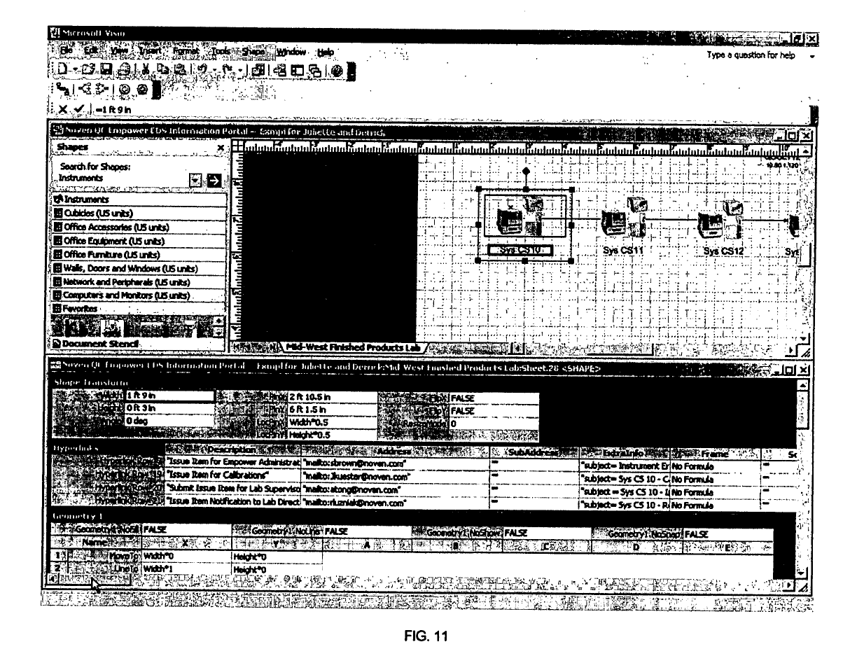

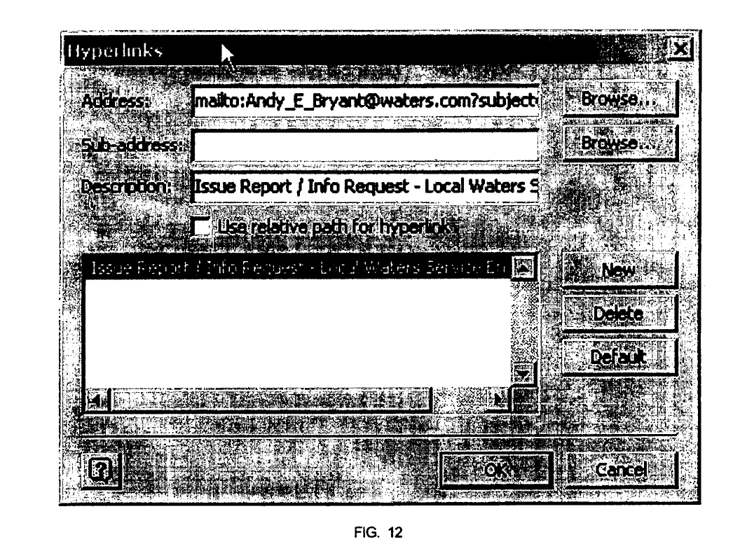

Within a Visio® drawing, hyperlinks may also be created. First a previously created drawing is selected to be edited. After a single graphic (i.e., shape) is selected, the hyperlink button from the main toolbar is selected, as illustrated in FIG. 8. A hyperlink window will appear that requests the entry of an address, as illustrated in FIG. 9. The address and description of the link are entered. In an exemplary embodiment of the invention, in which the Visio® page is to be displayed in the SampleManager™ LIMS, the “use relative path for hyperlink box” should be left unchecked for a link that triggers a procedure from the SampleManager™ master menu. The link should be tested to ensure it operates properly. The link may create an email or may include links to PDF files, Word files and/or instrument manuals, as illustrated in FIG. 10. The user may use the browse button to look for the file to be linked in the hyperlink window. Entry of information into the hyperlinks window is placed into the hyperlinks section of the Shapes Sheet, as illustrated in FIG. 11. A similar e-mail link can be setup to notify the local instrument service engineer when a problem or issue with an individual instrument or system arises, as illustrated in FIG. 12.

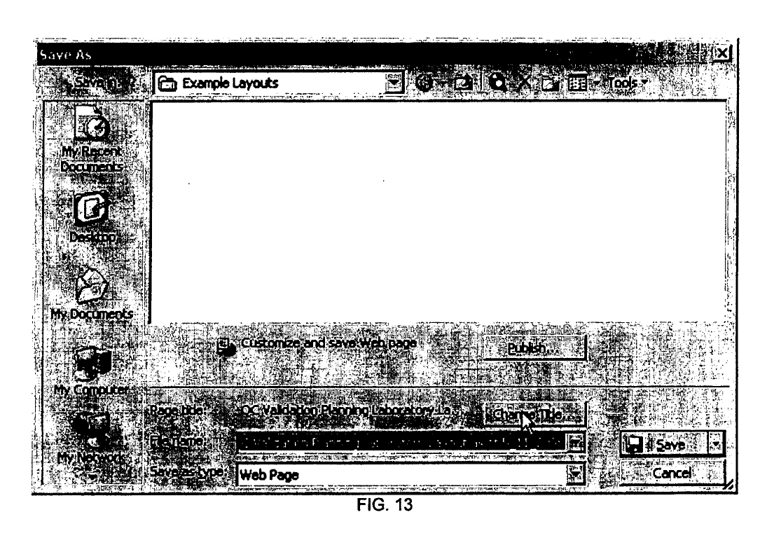

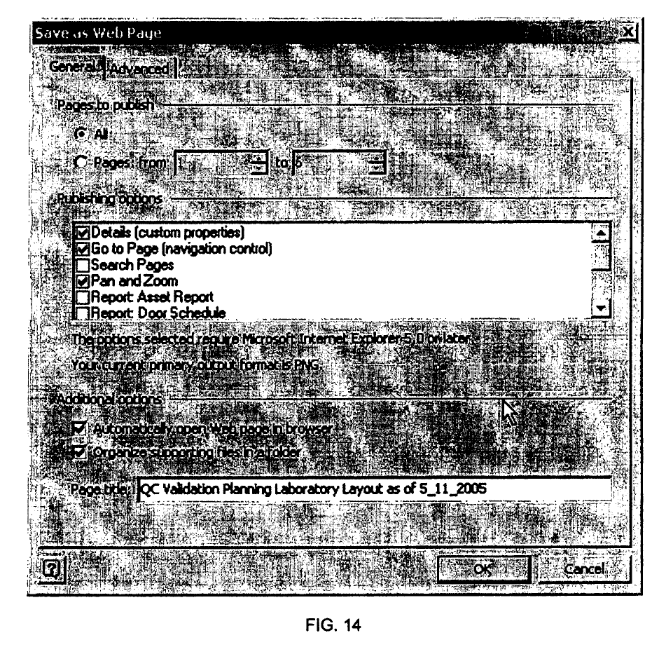

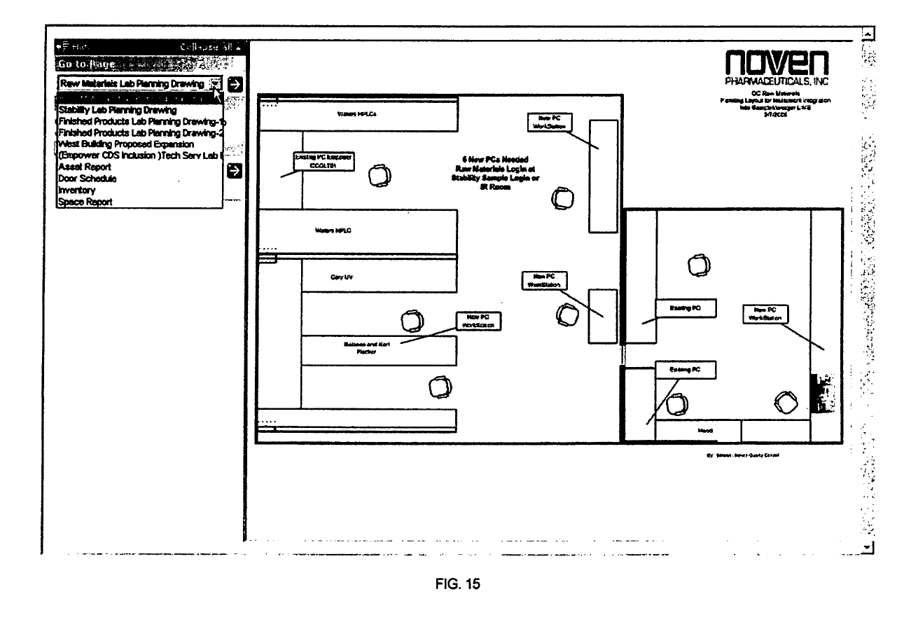

Visio® drawings may be saved and used as web pages on the Active Desktop. First, the drawing that is to be published for use as an Active Desktop is opened and saved as a webpage, as illustrated in FIG. 13. FIG. 14 illustrates a plurality of custom properties that may be selected while creating the webpage. It is helpful to select the option to organize supporting files in a folder to allow for the webpage and files to be moved to a different location later. In the Save As dialog box, the user navigates to the folder in which he/she wants to save the file and types the name for the webpage file in the File Name box. The title is entered in the Title Dialog box. The Publish option is selected to publish and specify the webpage publishing options. As illustrated in FIG. 15, the webpage is published to the selected location.

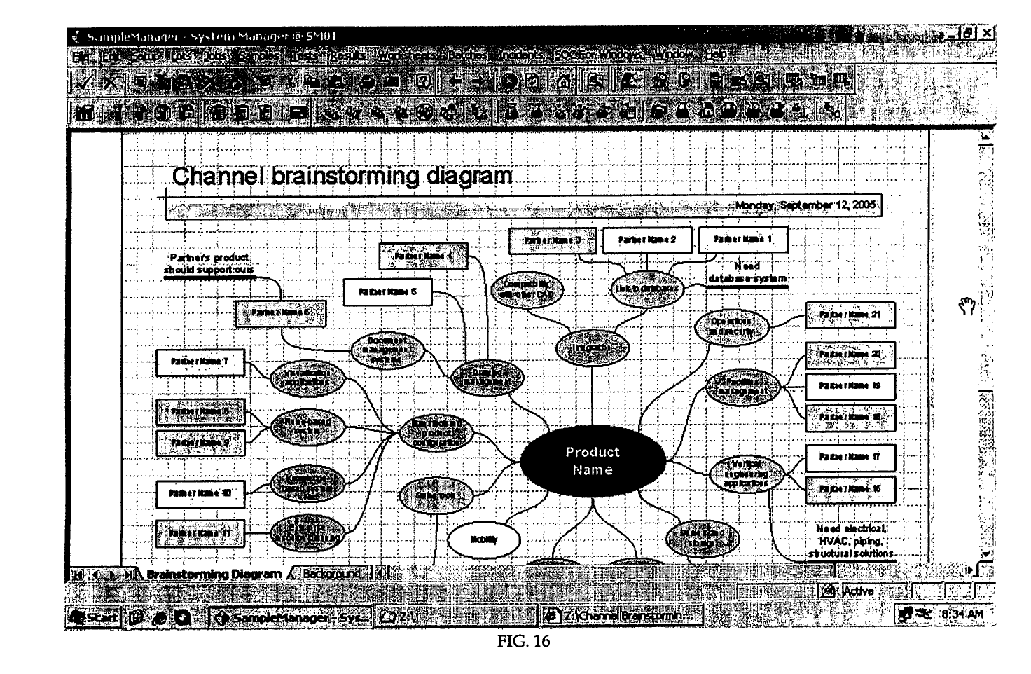

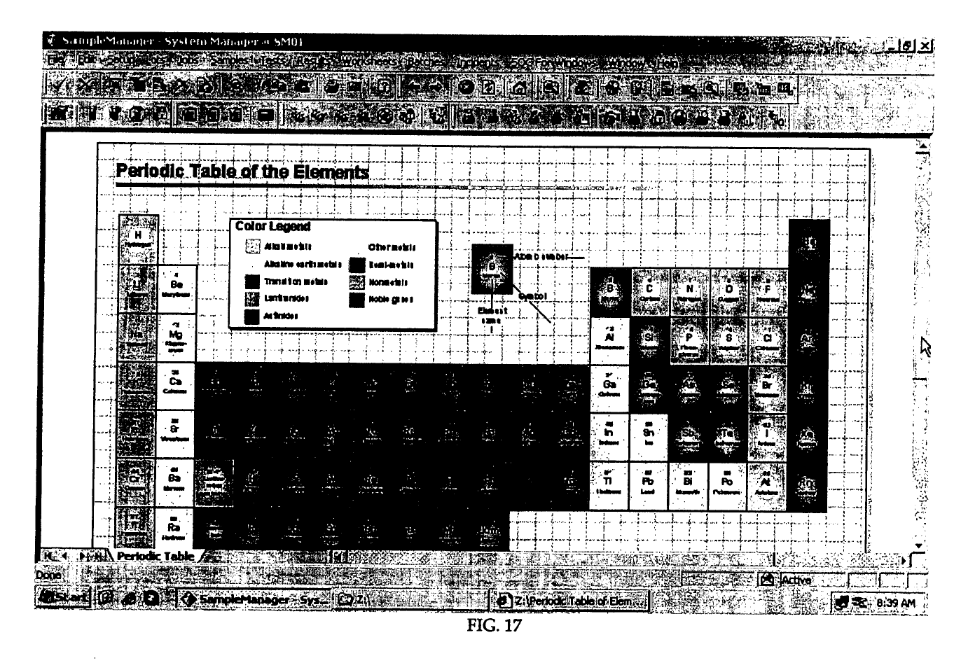

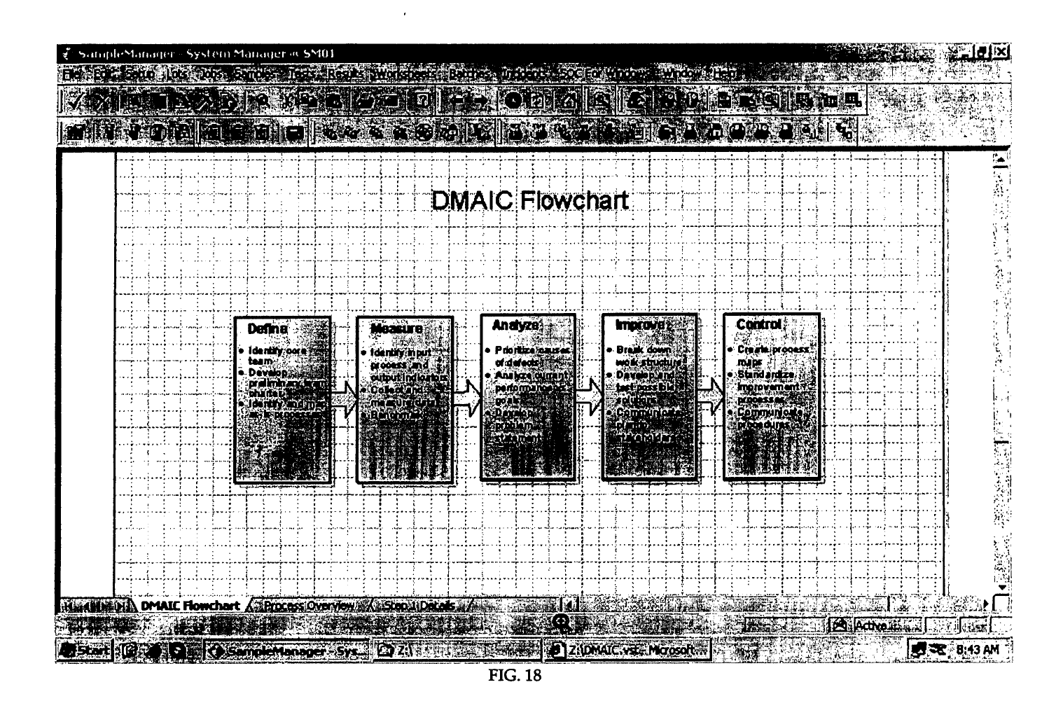

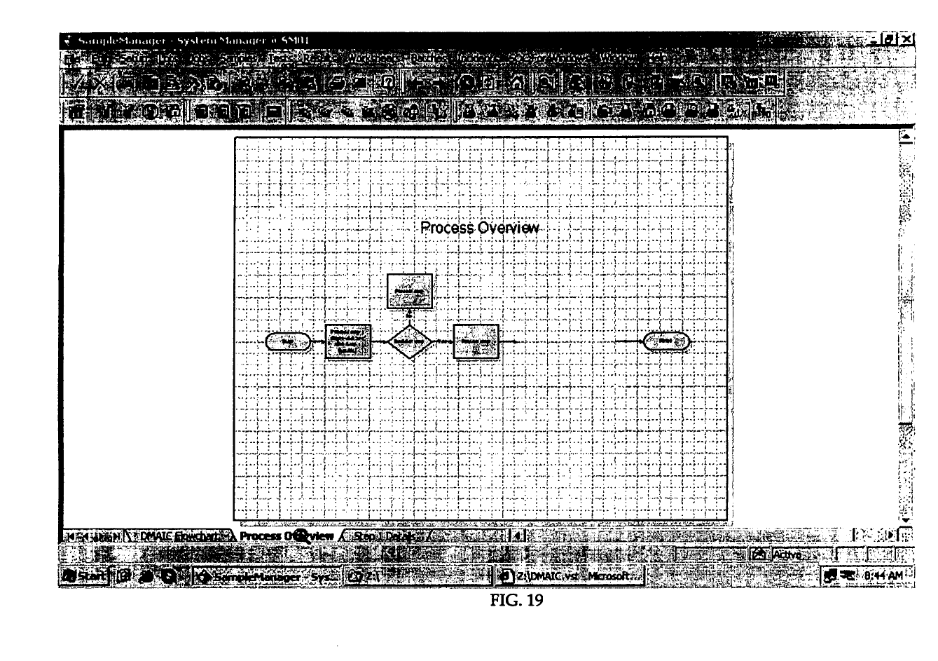

In an exemplary embodiment of the invention, laboratory specific Visio® stencils and templates are used to quickly and efficiently create web pages for display on the Active Desktop. These stencils and templates may also be used and incorporated into ASP.NET pages or used as a base for add-ins to LIMS (e.g., Enhanced Functionality Modules are application support modules created to extend the functionality of the base SampleManager application). Preformed stencils may be downloaded from the Microsoft webpage and viewed through the LIMS Active Desktop, as illustrated in FIGS. 16-19.

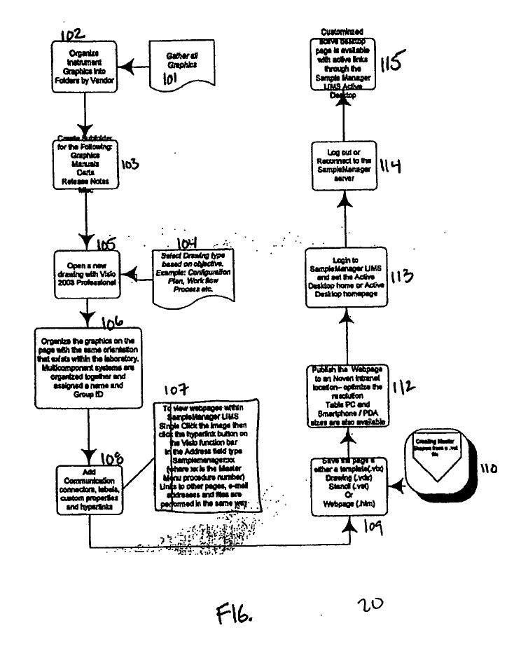

FIG. 20 illustrates a flowchart of the processes carried out to create and implement Visio® pages in LIMS. First the graphics for the instruments, for example, to be used in the web pages are gathered and organized in steps 102 and 103. Folders containing the graphics, manuals, release notes, certifications and other miscellaneous information may be organized into folders in step 103. After all of the information has been organized, a new drawing is opened in Visio®, in step 105. The drawing type is selected based on the objective (e.g., configuration plan, work flow process, etc.) in step 104. The graphics are organized in a manner that is consistent with the laboratory implementation in step 106. Multicomponent systems are organized together and assigned a group name and ID. In step 108, communication connectors, labels, custom properties and hyperlinks are added, which may be viewed and accessed in LIMS as noted in step 107. The drawing is then saved in step 109. The drawing may be stored in one of a plurality of formats including as a template, drawing, stencil or as a webpage, which may include Master Shapes input in step 110. The document is then optimized and published to the intranet, for example, in step 112 (e.g., the size and resolution may be optimized for viewing the webpage on a personal assistance device, Smartphone, etc.). Next, a user logs into the LIMS system and loads and sets the Active Desktop webpage(s) in step 113. After the user logs out and/or reconnects to the SampleManager™ server, for example, in step 114, the customized Active Desktop page is available through the LIMS Active Desktop in step 115. Accordingly, a user may then access the information graphically linked together by the Visio® webpage.

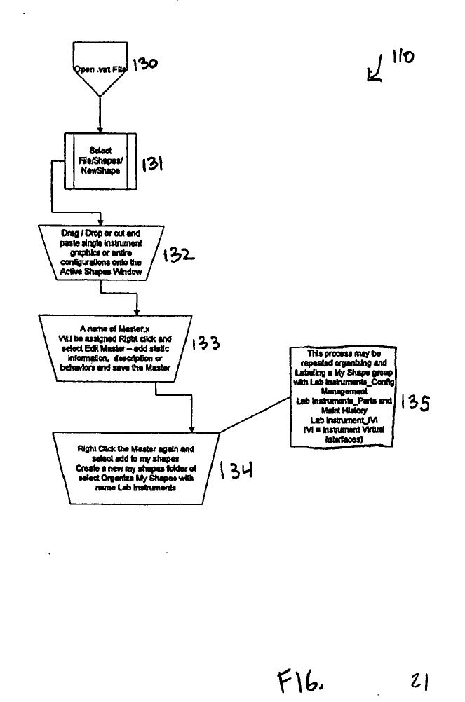

FIG. 21 illustrates an exemplary process for creating instrument configuration Shapes and MasterShapes in Visio®. First a .vst file is opened in step 130. A file, Shape or NewShape is selected in step 131. Next, in step 132 an instrument graphic or graphic configuration is placed into the Active Shapes window. The shape name is assigned in step 133. Static information, descriptive information and behavior information may also be added and linked to the Shape/MasterShape in this step. The newly created shape may then be added to the user's collection of Shapes/MasterShapes in step 134. Many Shapes/MasterShapes may be created and organized, for example, by instrument, part, configuration etc to create a My Shape group in step 135. The Shapes/MasterShapes may be used in the creation of the Visio® pages, as described above.

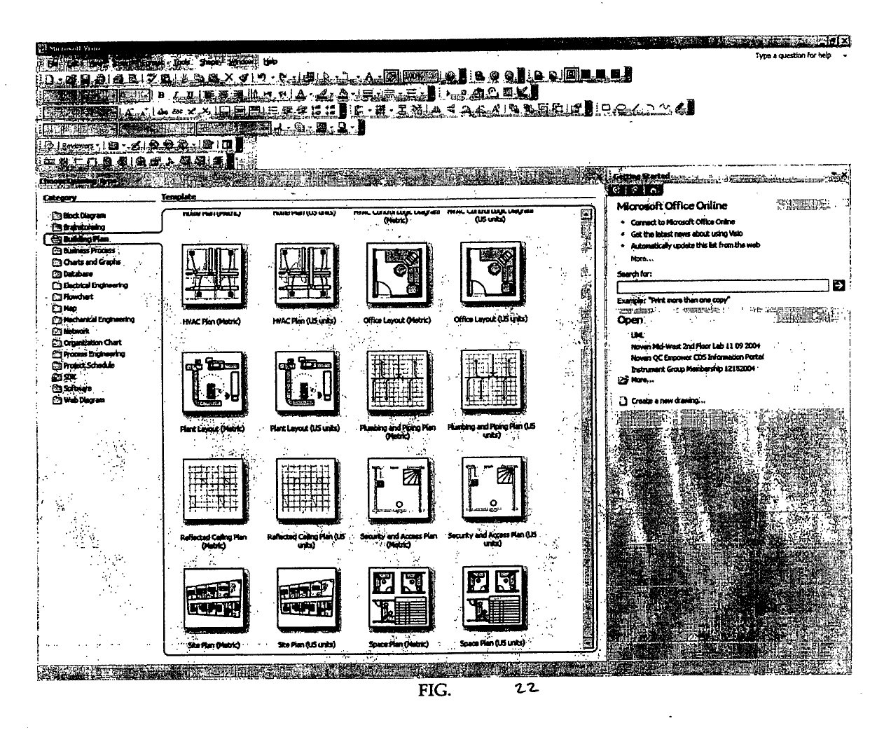

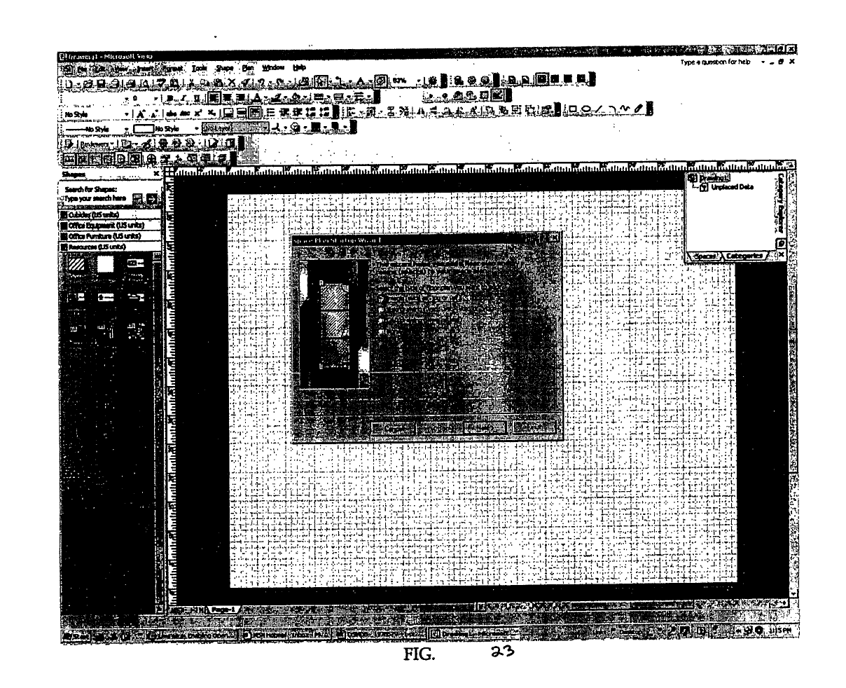

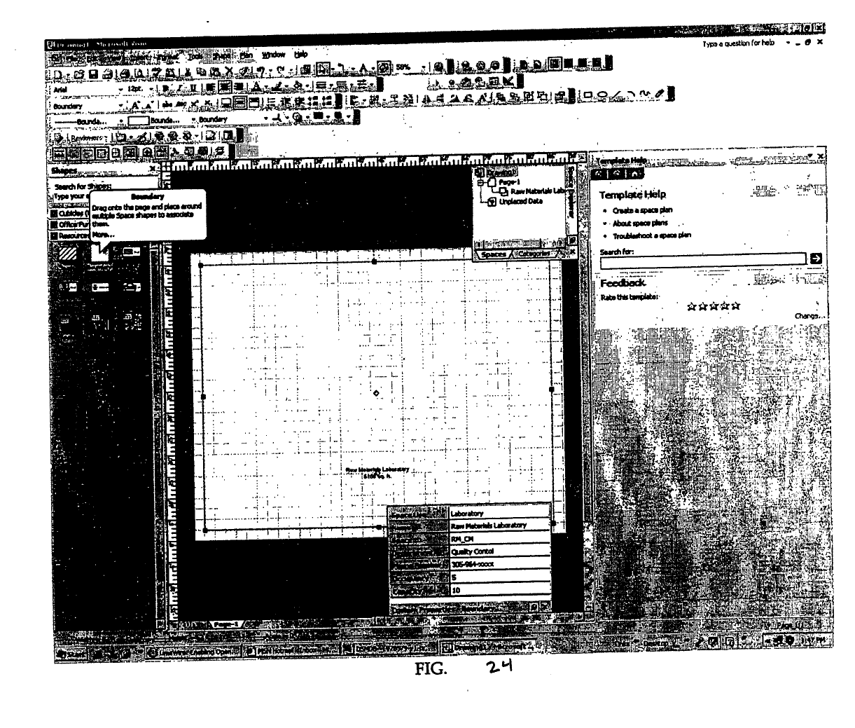

In an exemplary embodiment, a Visio® Space Plan is used to create a visual illustration of a pharmaceutical laboratory. In Visio®, a user first selects the type of drawing they wish to create, as illustrated in FIG. 22. To create the Space Plan, the user selects the Building Plan category. An existing Visio® drawing may be used to create the Space Plan or a new Space Plan may be created. The Space Plan Wizard, illustrated in FIG. 23, guides the user through initial selections, including the selection of type of floor plan or room to be added to a space plan. Once the floor plan has been opened and/or created, the Boundary Shapes may be dragged and inserted into the drawing, as illustrate in FIG. 24. The Boundary Shapes are illustrated in the left hand column of FIG. 24. The user may also assign custom properties to the Space Plan. The Space Plan is then saved as a stencil (e.g., Laboratory Space Plan Stencil) and may be added to the shapes window.

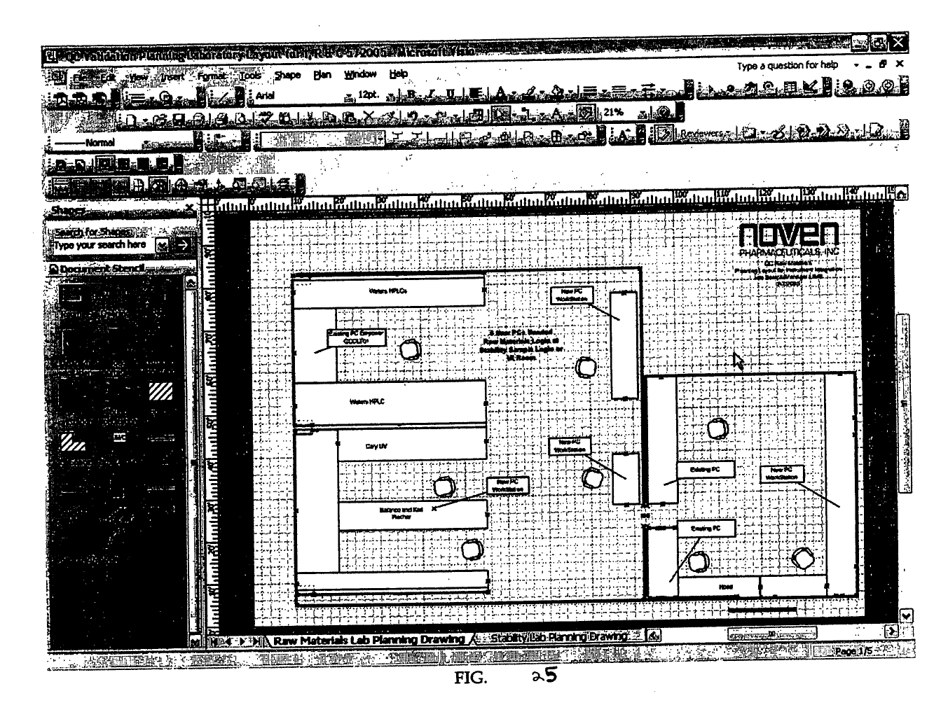

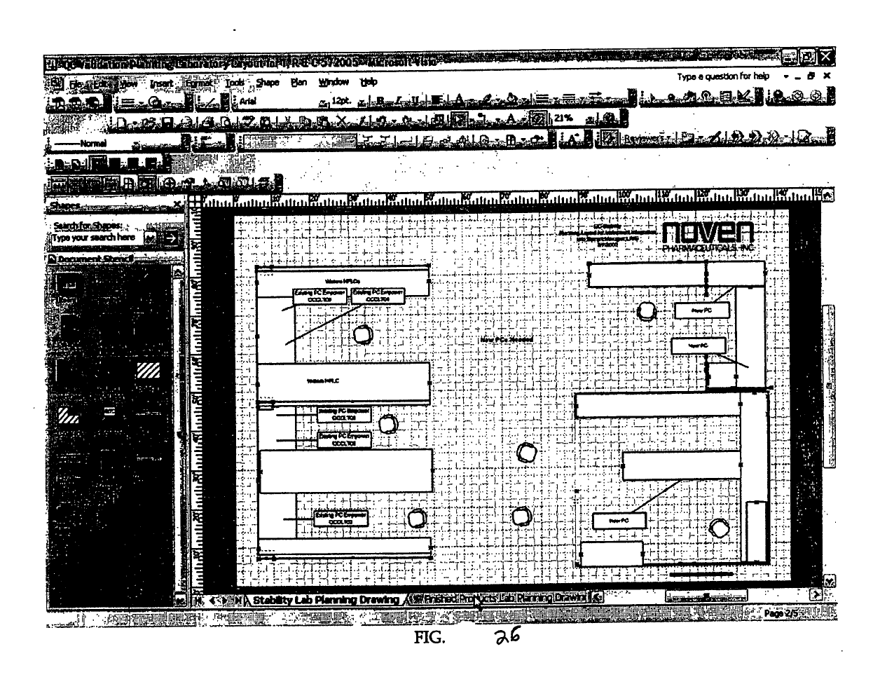

The user may then modify the Work Surface MasterShape located under the Laboratory Space Plan Stencil to create a Lab Bench MasterShape, for example. After the Laboratory Space Plan Stencil is selected for editing, custom MasterShapes, including newly created MasterShapes (e.g., Lab Bench MasterShape) and other Building Plan fixed furniture are added to the drawing, as illustrated in FIGS. 25-26. FIGS. 25-26 illustrate exemplary configured Space Plans. Once the finished layout is complete, it is saved as a template for the Configuration Change Request Document. This process of step by step creation of the floor plan can be automated and simplified by importing existing formatted drawings. Final layouts from a Visio® template may be used as the Configuration Change Control Request. The finalized Configuration Management Pages may be displayed through the SampleManager™ Active Desktop.

A reference directory is created to store information which can be linked directly to the Instrument Shape or Configuration Shape as a custom property. The collected and stored information may include graphics (e.g., instrument images that will be used for the MasterShapes and Shapes), calibration support documents, change control documentation (e.g., vendor issued, company specific), troubleshooting and maintenance documents (e.g., maintenance reports, configuration management reports), validation information (e.g., IQ, OQ, PQ reports, manufacturing valid forms and documents (e.g., release notes, certificates, manufacturing bulletins), and operational manuals (e.g., support documents, technical notes, and other miscellaneous documents which may include information on spare parts, training materials, and service engineer contact information, for example). The instrument graphics used on the Visio® pages may be created or may also be supplied from Vendor supplied documentation. Graphics may be extracted from the supplied documentation for quick utilization (e.g., from Vendor supplied PDF files). The graphics may later be organized into stencils as MasterShapes.

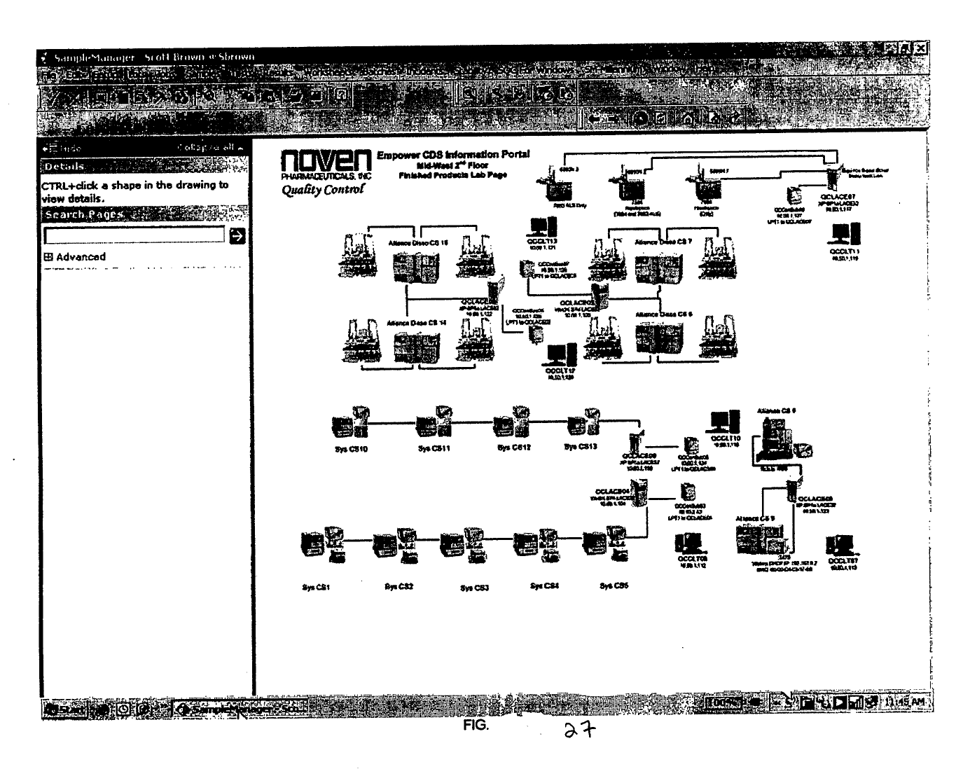

FIG. 27 illustrates an exemplary Visio® webpage viewed through the Active Desktop feature of SampleManager™. A plurality of laboratory instruments are graphically represented. A user of LIMS may select any of the graphical icons. Once a graphical icon is selected, the various documents associated with the instrument are accessible through the hyperlinks. The user may select manuals, release notes, installation instructions, sensitivity settings, etc. Additionally, the provided links may call items from the SampleManager™ master menu or open an email.

Further functional extensions to LIMS utilizing Visio® and Visio® 2003 viewer may be expanded to create the following capabilities: use of <SolutionML> </SolutionML> tags to embed well formed custom or non-native XML and/or use of SolutionML tags along with Apple Quicktime player or Adobe SVG player controls embedded into the Visio® drawings, stencils and templates which could be used to analyze IR spectroscopy data from Process automation sensors. Data or datasets obtained from these sensors could be viewed as 3D molecular geometrical structures to aid Research and Development and Process Automation Specialists to improve manufacturing process controls, product stability and overall product quality.

The processes and devices described above illustrate preferred methods and typical devices of many that could be used and produced. The above description and drawings illustrate embodiments, which achieve the objects, features, and advantages of the present invention. However, it is not intended that the present invention be strictly limited to the above-described and illustrated embodiments. Any modification, though presently unforeseeable, of the present invention that comes within the spirit and scope of the specification should be considered part of the present invention.

What is claimed as new and desired to be protected by Letters Patent of the United States is:

1. A graphical portal in an information management system, said system comprising:
a host computer; and
software capable of allowing a user to perform the steps comprising;
gathering and organizing graphics for said graphical portal, said graphics representing a particular item located in an environment,
opening a new or existing drawing,
adding said graphics to said drawings,
saving and publishing said drawing to an intranet,
logging onto said information management system from a remote computer, and
accessing said drawing from said remote computer.
